(19) United States
(12) Patent Application Publication
(10) Pub. No.: US 2016/0044196 A1
(43) Pub. Date: Feb. 11, 2016

(54) IMAGE PROCESSING APPARATUS

(71) Applicant: KYOCERA Document Solutions Inc., Osaka (JP)

(72) Inventor: Masaki Baba, Osaka (JP)

(21) Appl. No.: 14/818,350

(22) Filed: Aug. 5, 2015

(30) Foreign Application Priority Data
Aug. 8, 2014 (JP) 2014-163212

(51) Int. Cl. H04N 1/00; G06K 9/00

(52) U.S. Cl. CPC H04N 1/00809; G06K 9/00463

(57) ABSTRACT

This image processing apparatus identifies the orientation of a document image in a horizontally written text document. The image processing apparatus includes a character identification unit, a line identification unit, and an orientation identification unit. The character identification unit identifies a character bounding rectangle for every character in the document image based on extracted edges. The line identification unit merges the character bounding rectangles identified by the character identification unit to identify a plurality of line bounding rectangles. The orientation identification unit identifies the positions of a short side on one end and a short side on the other end, in the longitudinal direction, of each of the line bounding rectangles identified by the line identification unit to identify the orientation of the document image based on the positional distributions of the identified short sides of the line bounding rectangles.

### INCORPORATION BY REFERENCE

The disclosure of Japanese Patent Application No. 2014-163212 filed on Aug. 8, 2014 including the specification, drawings and abstract is incorporated herein by reference in its entirety.

### BACKGROUND

This disclosure relates to an image processing apparatus.

There are techniques for identifying the orientation of a document image read by an image reading apparatus.

For example, a method (the first method) identifies bounding rectangles of characters and bounding rectangles of lines in a document image to identify the orientation of the lines based on the positions of the bounding rectangles of the characters in the bounding rectangles of the lines. Another method (the second method) identifies the orientation of lines based on the positional relationship between the lines and punctuation marks in a document image.

### SUMMARY

According to one aspect of the present disclosure, the image processing apparatus identifies the orientation of a document image in a horizontally written text document. The image processing apparatus includes an edge extraction unit, a character identification unit, a line identification unit, and an orientation identification unit. The edge extraction unit extracts edges in the document image. The character identification unit identifies a character bounding rectangle for every character in the document image based on the extracted edges. The line identification unit merges the character bounding rectangles identified by the character identification unit to identify a plurality of line bounding rectangles. The orientation identification unit identifies the positions of a short side on one end and a short side on the other end, in the longitudinal direction, of each of the line bounding rectangles identified by the line identification unit to identify the orientation of the document image based on the positional distributions of the identified short sides of the line bounding rectangles.

### BRIEF DESCRIPTION OF THE DRAWINGS

FIG. 1 is a block diagram showing the configuration of an image processing apparatus according to an embodiment of the present disclosure.

FIG. 2 is a flow chart for describing an example of the processing performed by a line identification unit 3 in FIG. 1.

FIG. 3 is a flow chart for describing an example of the processing performed by an orientation identification unit 4 in FIG. 1.

FIG. 4 illustrates an example of corresponding relationships, which are referred to by the orientation identification unit 4 in FIG. 1, between an identified beginning side and orientation of a plurality of line bounding rectangles and an incremental value.

FIG. 5 illustrates an example of corresponding relationships, which are referred to by the orientation identification unit 4 in FIG. 1, between a positional relationship between a punctuation mark candidate and a line bounding rectangle and an incremental value.

### DETAILED DESCRIPTION

With reference to the accompanying drawings, an embodiment of the present disclosure will be described below.

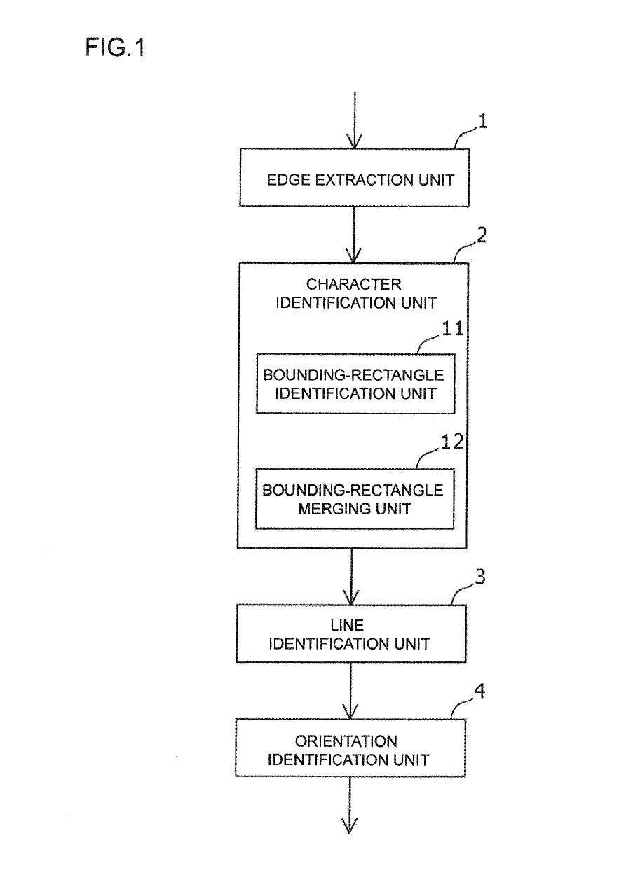

FIG. 1 is a block diagram showing the configuration of an image processing apparatus according to the embodiment of the disclosure. The image processing apparatus in FIG. 1 is implemented by, for example, an application specific integrated circuit (ASIC) or a computer. Image data of various types of images including original images is appropriately stored in a random access memory (RAM), a nonvolatile memory, or other types of memory devices. The ASIC or computer includes processors that implement the following processing units.

For example, image data of a document image captured from a horizontally written text document by an image reading apparatus or other apparatuses is supplied to an edge extraction unit 1. The horizontally written text document described herein denotes an original document containing text written horizontally and beginning from the left. The orientation of the document image changes depending on which orientation the horizontally written text document is placed on the image reading apparatus.

The edge extraction unit 1 extracts edges in the document image of the horizontally written text document. In this extraction process, the edge extraction unit 1 detects edges in the document image and creates an edge image composed of the detected edges. The edge image is a binary image indicating the location of high-intensity pixels of the detected edges. Specifically, the value of the high-intensity pixels of the detected edges is 1, and the value of the other pixels is 0. If the document image is a color image, the document image is firstly converted into an image having only luminance components of the document image, and then edges are extracted from the image.

A character identification unit 2 identifies a bounding rectangle of every character in the document image based on the edges extracted by the edge extraction unit 1 (i.e., in an edge image).

The character identification unit 2 includes a bounding-rectangle identification unit 11 and a bounding-rectangle merging unit 12.

The bounding-rectangle identification unit 11 extracts connected pixel sets (sequences of connected pixels) in the edge image by labeling, and identifies the bounding rectangles of the connected pixel sets.

In this processing, the bounding-rectangle identification unit 11 excludes connected pixel sets corresponding to rule lines based on the size and shape of the connected pixel sets.

The bounding-rectangle merging unit 12 detects a plurality of the connected pixel sets whose bounding rectangles are adjacent to one another and merges them into a single connected pixel set, thereby transforming the bounding rectangles of the connected pixel sets before being merged into a single bounding rectangle of the merged connected pixel sets. This processing identifies a single bounding rectangle for a single character composed of a plurality of discontinuous parts.

A line identification unit 3 merges the bounding rectangles of characters (hereinafter, referred to as “character bounding rectangles”) identified by the character identification unit 2 to identify a plurality of bounding rectangles of lines (hereinafter, referred to as “line bounding rectangles”).

The line identification unit 3 merges character bounding rectangles that are the closest to each other and also have a distance of less than a predetermined value therebetween in the main scanning direction or sub-scanning direction, and defines merged character bounding rectangles equal to or longer than a predetermined length in the main scanning direction or sub-scanning direction as line bounding rectangles.

Specifically, the line identification unit 3 firstly merges a character bounding rectangle with another character bounding rectangle, identifies the orientation of the merged character bounding rectangles as being the main scanning direction or sub-scanning direction based on the shape of the merged character bounding rectangles, and then merges the merged character bounding rectangles whose orientation has been identified with another character bounding rectangle along the identified orientation. In this manner, the character bounding rectangles are merged in the main scanning direction or sub-scanning direction.

An orientation identification unit 4 identifies the positions of a short side on one end and a short side on the other end of each of the line bounding rectangles, which have been identified by the line identification unit 3, in the longitudinal direction, thereby identifying the orientation of the document image based on the positional distributions of the identified short sides of the line bounding rectangles.

Specifically, for example, the orientation identification unit 4 compares the distribution of the identified short sides on one end with the distribution of the identified short sides on the other end of all the line bounding rectangles, and identifies the short sides on one of the ends less widely distributed as being the beginning side, thereby identifying the orientation of the document image based on the beginning side and orientation of the line bounding rectangles.

For example, the orientation identification unit 4 compares the distribution of the identified short sides on one end with the distribution of the identified short sides on the other end of all the line bounding rectangles, and identifies the short sides on one of the ends that are present in larger number within a range of a predetermined length (e.g., 1 mm) as being the beginning side, thereby identifying the orientation of the document image based on the identified beginning side and orientation of the line bounding rectangles.

In this embodiment, the orientation identification unit 4 identifies the orientation of the document image based on, in addition to the positions of the short sides identified for the line bounding rectangles, the positional distribution of character bounding rectangles within each line bounding rectangle in the direction of the short sides of the line bounding rectangle, and the positional relationship between a punctuation mark candidate and a line bounding rectangle. However, the orientation identification unit 4 can dispense with the positional distribution of character bounding rectangles within each line bounding rectangle in the direction of the short sides of the line bounding rectangle, and the positional relationship between a bounding rectangle of a punctuation mark candidate and a line bounding rectangle.

Next, the operation of the image processing apparatus will be described.

First, the edge extraction unit 1 extracts edges in a document image of a horizontally written text document, and then the character identification unit 2 identifies a bounding rectangle of every character in the document image based on the edges extracted by the edge extraction unit 1.

The line identification unit 3 merges the character bounding rectangles identified by the character identification unit 2 to identify a plurality of line bounding rectangles.

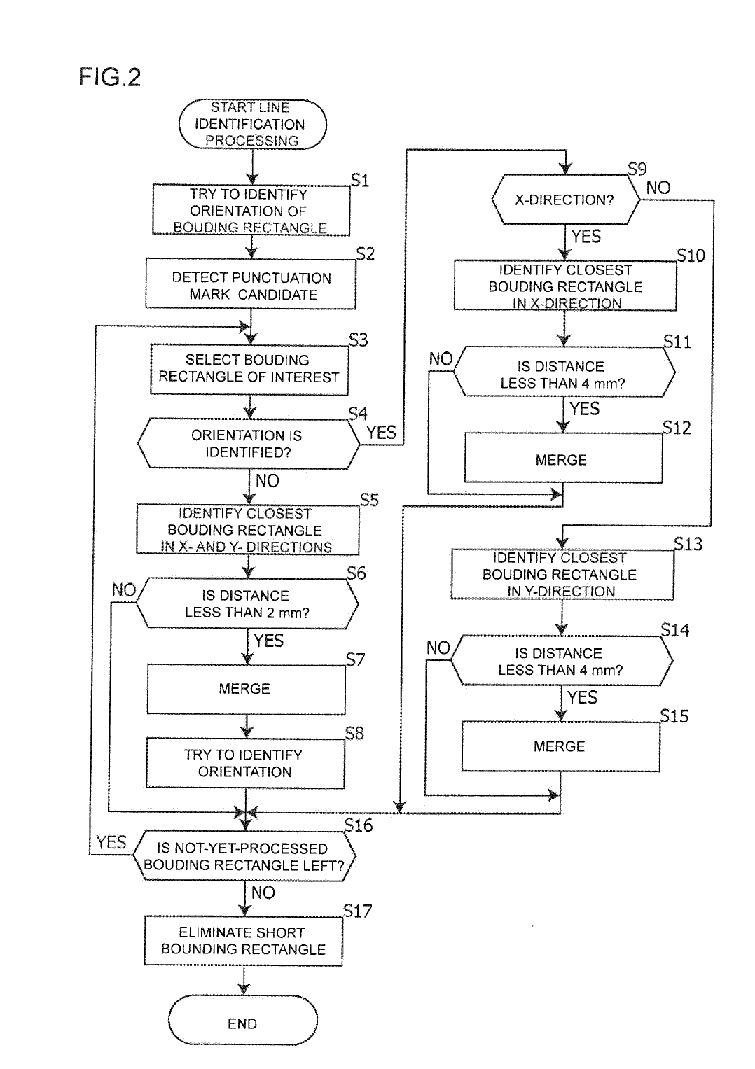

Detailed description about the processing by the line identification unit 3 will be made. FIG. 2 is a flow chart for describing an example of the processing by the line identification unit 3 in FIG. 1. Numeric values shown below are employed on the assumption that the character size of the document image is ranged from a standard character size (3.75 mm, 10.5 point) to the upper limit of regular-use character sizes (10 mm, 28 point). The following numeric values can be applicable if the character size to be used is 20 mm at the maximum.

First, the line identification unit 3 determines whether the long side of each of the character bounding rectangles (including merged bounding rectangles) obtained by the character identification unit 2 is twice or more than twice as long as the short side. The character bounding rectangles with the long side twice or more than twice as long as the short side are identified as being oriented in the direction along the long side (in the main scanning direction (hereinafter, referred to as X-direction) or sub-scanning direction (hereinafter, referred to as Y-direction)) (step S1).

In addition, among the character bounding rectangles obtained by the character identification unit 2, the line identification unit 3 categorizes character bounding rectangles of less than 1.6 mm in size (the longer one of the long side and short side) and also having a long side less than twice as long as the short side as punctuation mark candidates (step S2).

Among the character bounding rectangles obtained by the character identification unit 2, the line identification unit 3 selects character bounding rectangles of 1.6 mm or greater in size (the longer one of the long side and short side) to subject them to the following processing, but excludes the other character bounding rectangles from the processing in this description.

The line identification unit 3 then further selects a not-yet-processed bounding rectangle from the selected bounding rectangles as a bounding rectangle of interest (step S3).

The line identification unit 3 determines whether the orientation of the bounding rectangle of interest is identified (step S4).

If the orientation of the bounding rectangle of interest has not been identified, the line identification unit 3 identifies a bounding rectangle closest to the bounding rectangle of interest in the X-direction and Y-direction and measures the distance between the bounding rectangle of interest and the identified bounding rectangle (step S5).

Subsequently, the line identification unit 3 determines whether the distance is less than 2 mm (step S6). If the distance is determined to be less than 2 mm, the line identification unit 3 merges the bounding rectangle of interest with the identified bounding rectangle into a single bounding rectangle (step S7). Then, if the long side of the merged bounding rectangle is 1.5 times or more than 1.5 times as long as the short side, the line identification unit 3 defines the direction of the long side as the orientation of the merged bounding rectangle, while if the long side of the merged bounding rectangle is less than 1.5 times as long as the short side, the line identification unit 3 determines that the orientation of the merged bounding rectangle is unidentified (step S8).

On the other hand, if the distance is not less than 2 mm, the line identification unit 3 does not merge the bounding rectangle of interest with the identified bounding rectangle.

If the orientation of the bounding rectangle of interest is identified, the line identification unit 3 determines whether the bounding rectangle of interest is oriented in the X-direction (step S9).

If it is determined that the bounding rectangle of interest is oriented in the X-direction, the line identification unit 3 identifies a bounding rectangle closest to the bounding rectangle of interest in the X-direction, and measures the distance between the bounding rectangle of interest and the identified bounding rectangle (step S10).

Subsequently, the line identification unit 3 determines whether the distance is less than 4 mm (step S11). If the distance is determined to be less than 4 mm, the line identification unit 3 merges the bounding rectangle of interest with the identified bounding rectangle into a single bounding rectangle (step S12). Then, the line identification unit 3 defines the orientation of the bounding rectangle of interest as the orientation of the merged bounding rectangle.

On the other hand, if it is determined that the bounding rectangle of interest is not oriented in the X-direction (i.e., the bounding rectangle of interest is oriented in the Y-direction), the line identification unit 3 identifies a bounding rectangle closest to the bounding rectangle of interest in the Y-direction, and measures the distance between the bounding rectangle of interest and the identified bounding rectangle (step S13).

Subsequently, the line identification unit 3 determines whether the distance is less than 4 mm (step S14). If the distance is determined to be less than 4 mm, the line identification unit 3 merges the bounding rectangle of interest with the identified bounding rectangle into a single bounding rectangle (step S15). Then, the line identification unit 3 defines the orientation of the bounding rectangle of interest as the orientation of the merged bounding rectangle.

After the bounding rectangle of interest has been subjected to the above-described processing, the line identification unit 3 determines whether any not-yet-processed bounding rectangle (i.e., bounding rectangle not having been selected as a bounding rectangle of interest) is still left (step S16). Incidentally, the merged bounding rectangle is treated as a not-yet-processed bounding rectangle at the time of merging.

If a not-yet-processed bounding rectangle is left, the line identification unit 3 selects the not-yet-processed bounding rectangle as a bounding rectangle of interest, and performs the same processing on the selected bounding rectangle.

On the other hand, if any not-yet-processed bounding rectangle is not left, the line identification unit 3 eliminates short bounding rectangles, specifically bounding rectangles having a long side less than five times as long as the short side from the bounding rectangles obtained at this point of time, and defines the remaining bounding rectangles as line bounding rectangles (step S17).

After the plurality of line bounding rectangles in a document image are identified, the orientation identification unit 4 identifies the positions of a short side on one end and a short side on the other end for each of the line bounding rectangles, which have been identified by the line identification unit 3, in the longitudinal direction, thereby identifying the orientation of the document image based on the positional distributions of the identified short sides of the line bounding rectangles and some other factors.

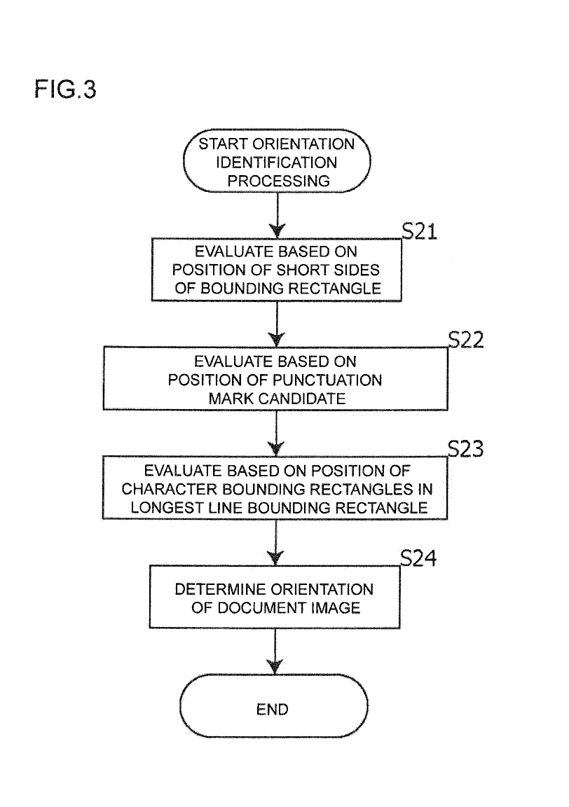

Detailed description about the processing by the orientation identification unit 4 will be made. FIG. 3 is a flow chart for describing an example of the processing by the orientation identification unit 4 in FIG. 1.

The orientation identification unit 4 identifies the orientation of the document image as being one of the following: an upside-up/a 0-degree turn (i.e., the upside of the document contents faces up in the document image); an upside-down/a 180-degree turn (i.e., the upside of the document contents faces down in the document image); an upside-right/a 270-degree turn (i.e., the upside of the document contents faces right in the document image); and an upside-left/a 90-degree turn (i.e., the upside of the document contents faces left in the document image).

In this description, counters are prepared for the upside-up, upside-down, upside-right, and upside-left orientations and the orientation identification unit 4 causes the counters to increment based on the evaluations below to finally define the orientation indicated by one of the counters with the highest value as the orientation of the document image.

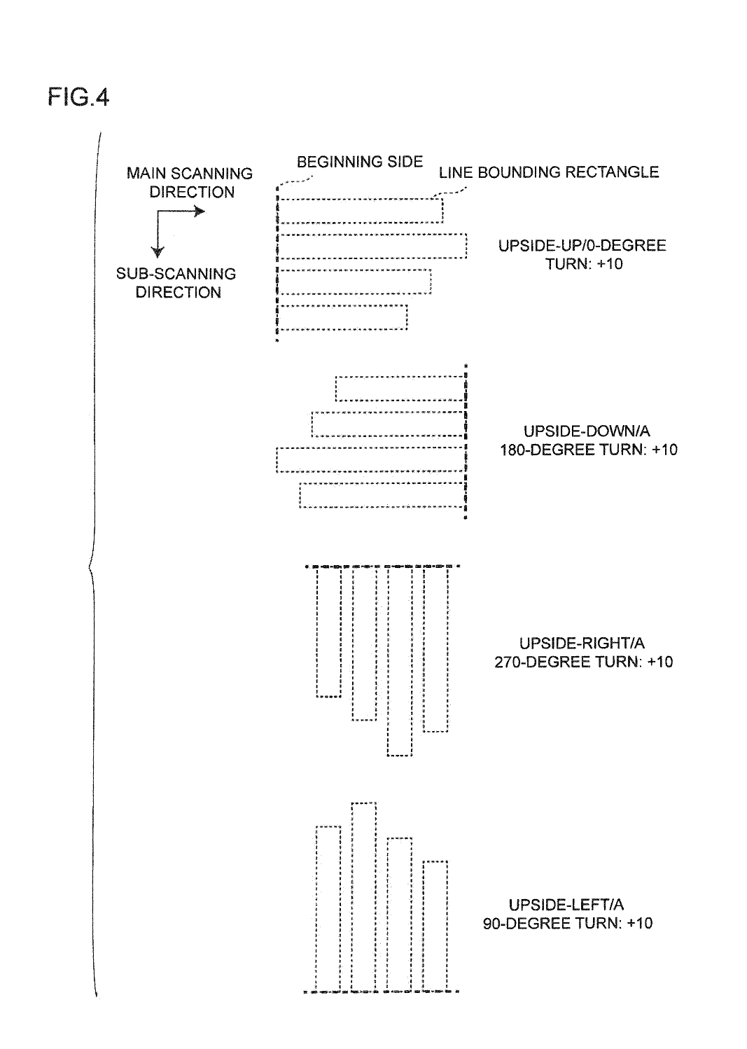

Specifically, the orientation identification unit 4 makes evaluations based on the positions of short sides of line bounding rectangles (step S21). FIG. 4 illustrates an example of corresponding relationships, which are referred to by the orientation identification unit 4 in FIG. 1, between an identified beginning side and orientation of the line bounding rectangles and an incremental value. The orientation identification unit 4 sets a left-side counter, a right-side counter, an upside counter, and a downside counter, and increments these counters as described below.

When line bounding rectangles oriented in the X-direction are more in number than line bounding rectangles oriented in the Y-direction, (a) the left-side counter is incremented by the number of only the line bounding rectangles whose left short side is located within a range of 1 mm in the X-direction out of the line bounding rectangles oriented in the X-direction, (b) the right-side counter is incremented by the number of only the line bounding rectangles whose right short side is located within a range of 1 mm in the X-direction out of the line bounding rectangles oriented in the X-direction, (c1) the upside-up counter is incremented by 10 if the value of the left-side counter is twice or more than twice as great as the value of the right-side counter, and (c2) the upside-down counter is incremented by 10 if the value of the right-side counter is twice or more than twice as great as the value of the left-side counter.

In this description, for example, one of the left short sides of the line bounding rectangles is chosen, and a count is taken of the other left short sides within 1 mm from the chosen left short side. This processing is performed on every left short side. Then, the left-side counter is incremented only by the maximum count out of all the counts. In addition, one of the right short sides of the line bounding rectangles is chosen, and a count is taken of the other right short sides within 1 mm from the chosen right short side. This processing is performed on every right short side. Then, the right-side counter is incremented only by the maximum count out of all the counts.

When line bounding rectangles oriented in the Y-direction are more in number than line bounding rectangles oriented in the X-direction, (a) the upside counter is incremented by the number of only the line bounding rectangles whose upper short side is located within a range of 1 mm in the Y-direction out of the line bounding rectangles oriented in the Y-direction, (b) the downside counter is incremented by the number of only the line bounding rectangles whose lower short side is located within a range of 1 mm in the Y-direction out of the line bounding rectangles oriented in the Y-direction, (c1) the upside-right counter is incremented by 10 if the value of the upside counter is twice or more than twice as great as the value of the downside counter, and (c2) the upside-left counter is incremented by 10 if the value of the downside counter is twice or more than twice as great as the value of the upside counter.

In this description, for example, one of the upper short sides of the line bounding rectangles is chosen, and a count is taken of the other upper short sides within 1 mm from the chosen upper short side. This processing is performed on every upper short side. Then, the upside counter is incremented only by the maximum count out of all the counts. In addition, one of the lower short sides of the line bounding rectangles is chosen, and a count is taken of the other lower short sides within 1 mm from the chosen lower short side. This processing is performed on every lower short side. Then, the downside counter is incremented only by the maximum count out of all the counts.

In short, step S21 compares the positional distribution of the identified short sides on one end with the positional distribution of the identified short sides on the other end of line bounding rectangles, identifies the short sides on one of the ends less widely distributed as being the beginning side, thereby evaluating the orientation of the document image based on the identified beginning side and orientation of the line bounding rectangles.

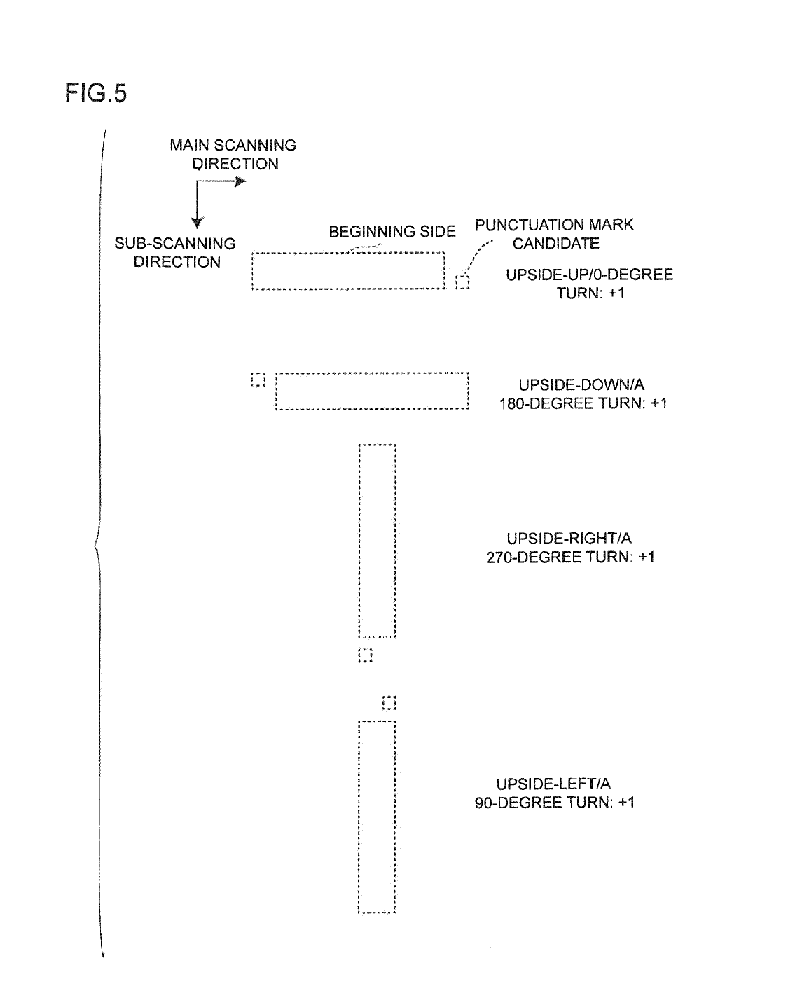

Next, the orientation identification unit 4 makes evaluations based on the positions of punctuation mark candidates (step S22). FIG. 5 illustrates an example of corresponding relationships, which are referred to by the orientation identification unit 4 in FIG. 1, between a positional relationship between a punctuation mark candidate and a line bounding rectangle and an incremental value.

First, the orientation identification unit 4 excludes punctuation mark candidates located within 4 mm from the border between an available image region (inside of margins) and margins.

Then, the orientation identification unit 4 identifies line bounding rectangles closest to punctuation mark candidates and excludes the punctuation mark candidates if the identified line bounding rectangles are less than 3 mm in size (in the X-direction and Y-direction) and are less than twice as great as the size of the punctuation mark candidates.

In addition, the orientation identification unit 4 excludes the punctuation mark candidates that overlap with the closest line bounding rectangles.

Furthermore, in the case where the closest line bounding rectangles are oriented in the X-direction, the orientation identification unit 4 excludes the punctuation mark candidates that are ⅓ or more than ⅓ in size in the Y-direction of the closest line bounding rectangles in the Y-direction. In the case where the closest line bounding rectangles are oriented in the Y-direction, the orientation identification unit 4 excludes the punctuation mark candidates that are ⅓ or more than ⅓ in size in the X-direction of the closest line bounding rectangle in the X-direction.

For the remaining punctuation mark candidates, the orientation identification unit 4 increments: (a) the upside-up counter by 1 if a punctuation mark candidate lies on the lower right side of the closest line bounding rectangle oriented in the X-direction, and the upside-down counter by 1 if a punctuation mark candidate lies on the upper left side of the closest line bounding rectangle oriented in the X-direction; and (b) the upside-right counter by 1 if a punctuation mark candidate lies on the lower left side of the closest line bounding rectangle oriented in the Y-direction, and the upside-left counter by 1 if a punctuation mark candidate lies on the upper right side of the closest line bounding rectangle oriented in the Y-direction.

Subsequently, the orientation identification unit 4 makes evaluations based on the positions of character bounding rectangles in the longest line bounding rectangle (step S22). In this description, the orientation identification unit 4 sets a first upside counter, a second upside counter, a first downside counter, a second downside counter, a first right-side counter, a second right-side counter, a first left-side counter, and a second left-side counter, and increments these counters as described below.

If line bounding rectangles oriented in the X-direction are more in number than line bounding rectangles oriented in the Y-direction, a line bounding rectangle containing the greatest number of character bounding rectangles merged therein is identified from the line bounding rectangles oriented in the X-direction. The orientation identification unit 4 determines whether the number of the character bounding rectangles merged in the identified line bounding rectangle is greater than 8. In only the case where the number of the character bounding rectangles merged in the identified line bounding rectangle is determined as being greater than 8, the counters are incremented as described below.

In this case, the following processing is performed for each of the character bounding rectangles merged in the identified line bounding rectangle: (a) if the upper side of a character bounding rectangle in the Y-direction is located at a position corresponding to more than ⅛ the size of the identified line bounding rectangle from the lower side of the line bounding rectangle in the Y-direction and also is located greater than 0.5 mm from the lower side of the line bounding rectangle in the Y-direction, the first upside counter is incremented by 1; and (b) if the lower side of a character bounding rectangle in the Y-direction is located at a position corresponding to more than ⅛ the size of the identified line bounding rectangle from the lower side of the line bounding rectangle in the Y-direction and also is located greater than 0.5 mm from the lower side of the line bounding rectangle in the Y-direction, the first downside counter is incremented by 1. After the above-described evaluations have been done for every character bounding rectangle merged in the identified line bounding rectangle, (c1) the upside-up counter is incremented by 3 if the value of the first upside counter is more than five times as great as the value of the first downside counter, while (c2) the upside-down counter is incremented by 3 if the value of the first downside counter is more than five times as great as the value of the first upside counter.

Furthermore, the following processing is performed for each of the character bounding rectangles merged in the identified line bounding rectangle: (a) if the upper side of a character bounding rectangle in the Y-direction is located at a position corresponding to ⅛ or less than ⅛ the size of the identified line bounding rectangle from the lower side of the line bounding rectangle in the Y-direction and also is located 0.5 mm or less than 0.5 mm from the lower side of the line bounding rectangle in the Y-direction, the second upside counter is incremented by 1; and (b) if the lower side of a character bounding rectangle in the Y-direction is located at a position corresponding to ⅛ or less than ⅛ the size of the identified line bounding rectangle from the lower side of the line bounding rectangle in the Y-direction and also is located 0.5 mm or less than 0.5 mm from the lower side of the line bounding rectangle in the Y-direction, the second downside counter is incremented by 1. After the above-described evaluations have been done for every character bounding rectangle merged in the identified line bounding rectangle, (c1) the upside-up counter is incremented by 3 if the value of the second downside counter is more than 1.5 times as great as the value of the second upside counter, and (c2) the upside-down counter is incremented by 3 if the value of the second upside counter is more than 1.5 times as great as the value of the second downside counter.

On the other hand, if line bounding rectangles oriented in the Y-direction are more in number than line bounding rectangles oriented in the X-direction, a line bounding rectangle containing the greatest number of character bounding rectangles merged therein is identified from the line bounding rectangles oriented in the Y-direction. The orientation identification unit 4 determines whether the number of the character bounding rectangles merged in the identified line bounding rectangle is greater than 8. In only the case where the number of the character bounding rectangles merged in the identified line bounding rectangle is determined as being greater than 8, the counters are incremented as described below.

In this case, the following processing is performed for each of the character bounding rectangles merged in the identified line bounding rectangle: (a) if the left side of the character bounding rectangle in the X-direction is located at a position corresponding to more than ⅛ the size of the identified line bounding rectangle from the left side of the line bounding rectangle in the X-direction and also is located greater than 0.5 mm from the left side of the line bounding rectangle in the X-direction, the first left-side counter is incremented by 1; and (b) if the right side of the character bounding rectangle in the X-direction is located at a position corresponding to more than ⅛ the size of the identified line bounding rectangle from the left side of the line bounding rectangle in the X-direction and also is located greater than 0.5 mm from the left side of the line bounding rectangle in the X-direction, the first right-side counter is incremented by 1. After the above-described evaluations have been done for every character bounding rectangle in the identified line bounding rectangle, (c1) the upside-left counter is incremented by 3 if the value of the first left-side counter is more than five times as great as the value of the first right-side counter, and (c2) the upside-right counter is incremented by 3 if the value of the first right-side counter is more than five times as great as the value of the first left-side counter.

Furthermore, the following processing is performed for each of the character bounding rectangles merged in the identified line bounding rectangle: (a) if the left side of a character bounding rectangle in the X direction is located at a position corresponding to ⅛ or less than ⅛ the size of the identified line bounding rectangle from the left side of the line bounding rectangle in the X-direction and also is located 0.5 mm or less than 0.5 mm from the left side of the line bounding rectangle in the X-direction, the second left-side counter is incremented by 1; and (b) if the right side of the character bounding rectangle in the X direction is located at a position corresponding to ⅛ or less than ⅛ the size of the identified line bounding rectangle from the left side of the line bounding rectangle in the X-direction and also is located 0.5 mm or less than 0.5 mm from the left side of the line bounding rectangle in the X-direction, the second right-side counter is incremented by 1. After the above-described evaluations have been done for every character bounding rectangle merged in the identified line bounding rectangle, (c1) the upside-left counter is incremented by 3 if the value of the second right-side counter is more than 1.5 times as great as the value of the second left-side counter, and (c2) the upside-right counter is incremented by 3 if the value of the second left-side counter is more than 1.5 times as great as the value of the second right-side counter.

Upon completion of the evaluations, the orientation identification unit 4 defines the orientation indicated by one of the upside-up counter, upside-down counter, upside-right counter, and upside-left counter, having the highest count, as the orientation of the document image (step S24).

According to the embodiment described above, the line identification unit 3 identifies a plurality of line bounding rectangles by merging character bounding rectangles identified by the character identification unit 2, and the orientation identification unit 4 identifies the positions of short sides on one end and the other end in the longitudinal direction of every identified line bounding rectangle, thereby identifying the orientation of the document image based on the positional distributions of the identified short sides of the line bounding rectangles.

This embodiment can quickly identify the orientation of document image in a document horizontally written in a specific language (e.g., Asian languages, uppercase alphabetic characters, etc.) without execution of character recognition processing (OCR processing) that requires reference to dictionaries. Therefore, this embodiment can dispense with a memory area for the dictionaries required for the OCR processing.

Although the foregoing embodiment is a preferred example of the present disclosure, it is to be noted that the present disclosure is not limited by the embodiment, and that various modifications and changes can be made without departing from the spirit of the present disclosure.

For example, the numeric values mentioned in the above embodiment are merely examples and therefore are appropriately variable according to the types of languages.

The present disclosure is applicable to image forming apparatuses, such as scanners and multi-function peripherals.

What is claimed is:

1. An image processing apparatus that identifies the orientation of a document image in a horizontally written text document comprising:
an edge extraction unit configured to extract edges in the document image;
a character identification unit configured to identify a bounding rectangle for every character in the document image based on the extracted edges;
a line identification unit configured to merge the character bounding rectangles identified by the character identification unit to identify a plurality of line bounding rectangles; and
an orientation identification unit configured to identify the positions of a short side on one end and a short side on the other end of each of the line bounding rectangles, identified by the line identification unit, in the longitudinal direction to identify the orientation of the document image based on the positional distributions of the identified short sides of the line bounding rectangles.

2. The image processing apparatus according to claim 1, wherein
the line identification unit merges each of the character bounding rectangles with the other character bounding rectangle that is closest thereto and also at a distance of less than a predetermined value therefrom in a main scanning direction or a sub-scanning direction, and defines merged character bounding rectangles having a predetermined length or longer in the main scanning direction or sub-scanning direction as line bounding rectangles.

3. The image processing apparatus according to claim 2, wherein
after merging the character bounding rectangles, the line identification unit identifies the orientation of the merged character bounding rectangles as being the main scanning direction or sub-scanning direction based on the shape of the merged character bounding rectangles, and then merges the merged character bounding rectangles whose orientation has been identified with another character bounding rectangle along the identified orientation.

4. The image processing apparatus according to claim 1, wherein
the orientation identification unit compares the distribution of the identified short sides on one end with the distribution of the identified short sides on the other end of all the line bounding rectangles, identifies the short sides on one of the ends less widely distributed as being a beginning side, and identifies the orientation of the document image based on the identified beginning side and orientation of the line bounding rectangles.

5. The image processing apparatus according to claim 1, wherein
the orientation identification unit compares the distribution of the identified short sides on one end with the distribution of the identified short sides on the other end of all the line bounding rectangles, identifies the short sides on one of the ends that are present in larger number within a range of a predetermined length as being a beginning side, and identifies the orientation of the document image based on the identified beginning side and the orientation of the line bounding rectangles.

6. The image processing apparatus according to claim 1, wherein
the orientation identification unit identifies the orientation of the document image based on, in addition to the distributions of the short sides, a positional relationship between a punctuation mark candidate in the character bounding rectangles and a line bounding rectangle, and the positions of character bounding rectangles in the line bounding rectangle.
